(19) United States
(12) Patent Application Publication
(10) Pub. No.: US 2001/0033069 A1
(43) Pub. Date: Oct. 25, 2001

(54) Infant/child stroller board attachment

(76) Inventor: Donald E. Ivers, Santa Barbara, CA (US)

Correspondence Address: Donald E. Ivers, 4070 La Barbara Drive, Santa Barbara, CA, 93111, US

(21) Appl. No.: 09/764,940

(22) Filed: Jan. 17, 2001

Related U.S. Application Data
(60) Provisional application No. 60/176,505, filed on Jan. 18, 1999.

(51) Int. Cl. B62B 1/00

(52) U.S. Cl. 280/648; 280/87.041

(57) ABSTRACT

A wheeled board that is attached to the back of a baby stroller is disclosed. The stroller and board are propelled in the same way as a scooter. The parent pushes against the ground with one foot, while keeping the other foot on the board. When both are moving, the parent can place both feet on the board and the board and stroller will roll in unison. The wheeled board consists of a rigid material such as wood with the top surface for standing. Two wheels are mounted on the bottom surface of the board at one end. At the other end, the board has a bracket for connecting it to the stroller and in the preferred embodiment, the bracket is attached to the stroller's rear wheel axle. The bracket provides a pivot point between the board and the stroller. The board is steered in unison with the stroller by the parent shifting the weight over the board to pivot the board on its longitudinal axis and by the parent changing the angle between the board and stroller.

This application claims the benefit of provisional application Ser. No. 60/1176,505 to Ivers, that was filed on Jan. 18, 2000.

### BACKGROUND OF THE INVENTION

1. Field of the Invention

This invention relates to infant strollers and more particularly to a wheeled board that can be removably attached to a stroller.

2. Description of the Related Art

Many parents and child-care providers take infants and young children with them during their exercise and activity routines. Numerous devices have been developed for this purpose including strollers, child carrying backpacks, child bicycle seats, and child bicycle trailers. There have been numerous advancements in strollers that allow them to be pushed when jogging, roller-skating, roller blading, hiking, or the like. See U.S. Pat. No. 5,876,309 to Archey, U.S. Pat. No. 5,669,624 to Eichhorn and U.S. Pat. No. 5,562,300 to Nelson. Many of the advancements relate to stability, steerability and ease of use. All terrain strollers have even been developed for taking infants/children off-road hiking or strolling. See U.S. Pat. No. 5,975,559 to Zonka.

However, using a stroller while jogging or roller-skating can be awkward and dangerous. At least one hand must be kept on the stroller at all times, interfering with the natural jogging or roller skating stride. Also, there is no stable attachment to stroller. If the jogger or roller skater falls, he/she must release the stroller or cause the stroller tip. In either case this can be dangerous for the child in the stroller. Often, this becomes so awkward or dangerous that the activity is discontinued.

### SUMMARY OF THE INVENTION

The present invention consists of a wheeled board that is attached to the back of a baby stroller. The child is placed in the stroller and the parent or child-care provider (hereinafter referred to as parent) stands on the board while holding the stroller handles. The stroller and board are propelled in the same way as a scooter. The parent pushes against the ground with one foot, while keeping the other foot on the board. When both are moving, the parent can place both feet on the board and the board and stroller will roll in unison.

The wheeled board consists of a rigid material such as wood with the top surface for standing. Two wheels are mounted on the bottom surface of the board at one end. At the other end, the board has a bracket for connecting it to the stroller and in most cases, the bracket is attached to the stroller's rear wheel axle. The bracket provides a pivot point between the board and the stroller. The bracket allows the board to pivot about its longitudinal axis over the board wheels. The bracket also allows the horizontal angle between the board and the stroller to be varied. The board is steered in unison with the stroller by the parent shifting the weight over the board to pivot the board on its longitudinal axis and by the parent changing the angle between the board and stroller.

The bracket also has a quick release mechanism that allows the board to be quickly and easily removed from the stroller. It also has a hinge that allows its wheeled end to be lifted and rotated about the bracket such that it can be fastened and stored to the back of the stroller. This allows the stroller to be used for jogging, walking, etc., without removing the board from the stroller.

The board and stroller combination provides a stable, safe and efficient platform for propelling the stroller. The combination provides a new way for the parent to exercise while safely taking their children out in a stroller.

These and other further features and advantages of the invention will be apparent to those skilled in the art from the following detailed description, taken together with the accompanying drawings, in which:

### BRIEF DESCRIPTION OF THE DRAWINGS

FIG. 1 is a perspective view of the new wheeled board attached to a jogging stroller;

FIG. 2 is a side view of the new wheeled board FIG. 3 is a bottom view of the new wheeled board;

FIG. 4 is a plan view of one embodiment of the bracket used on the new wheeled board; and

FIG. 5 is a sectional view of the nut and bolt assembly with the rubber sleeves.

### DETAILED DESCRIPTION OF THE INVENTION

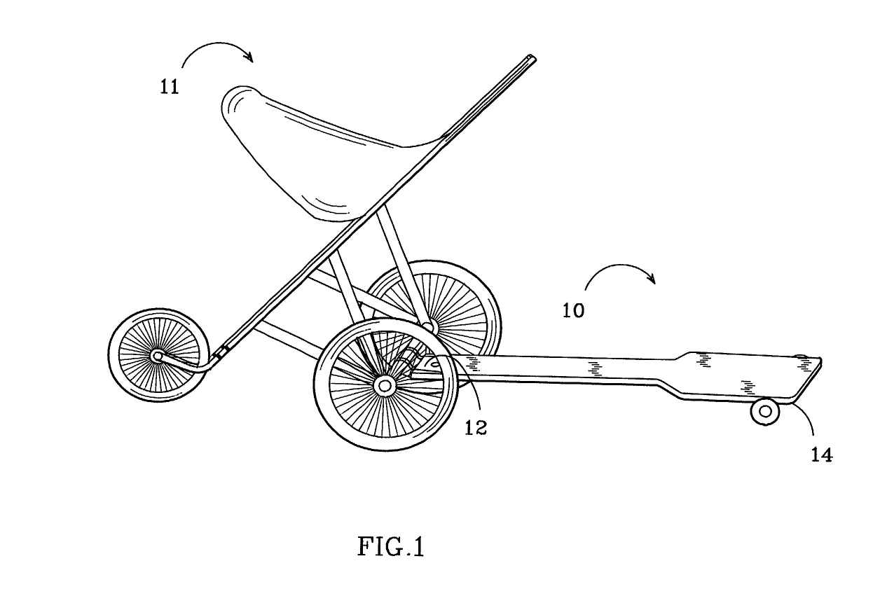

FIGS. 1-3 show the new wheeled board constructed in accordance with the invention. In FIG. 1, the new wheeled board 10 is attached to a conventional jogging stroller 11 by a bracket 12. In the preferred embodiment, the bracket 10 is attached to the axle 13 between the two rear wheels of the stroller, although the board can be attached to the stroller in different locations. The bracket is sturdy enough to support the weight of the parent and the contact point on the stroller is also strong enough to support the parent. The board 10 pivots around the bracket on the stroller 11 to allow the board 10 to be steered.

In the preferred embodiment, the board 10 has two wheels 14 mounted to its bottom surface by a mounting mechanism such that the wheels contact the ground and roll on the ground when the board 10 is propelled. Alternative embodiments can have one wheel or more than two wheels. The wheels 14 and wheel mounting mechanism are sturdy enough to support the parent's weight. The mounting mechanism has an axle that is perpendicular to the board and the board pivots over the mounting mechanism, changing the angle between the board and axle. This also allows the board to be steered. The board 10 is made of a rigid material such as wood, metal, or plastic, that is sturdy enough to support a person between the wheels and bracket, with the preferred board being made of wood.

The parent stands on the new board 10, with his/her feet toward its wheeled end. He/she holds the stroller with both hands on the stroller, in the normal holding position. With one foot still on the board 10, the user propels the board and stroller forward by pushing against the ground with the other foot, much the same way a common scooter is propelled. To obtain greater speed, the user can repeat this process. When the desired speed is reached, the parent can place both feet on the board with the board and stroller rolling in unison. Alternatively, the board and stroller can be propelled by the parent holding on to the stroller, running behind the stroller and stepping onto the new board 10 when the desired speed is reached.

The stroller 11 is steered in unison with the stroller 11 in much the same way a skateboard is steered; by the parent shifting his/her weight over the board 10 and pivoting it about the bracket 12 and wheel mechanism as shown by arrows 11a. The horizontal angle 13 between the board 10 and stroller can also be varied to assist in steering. The board 10 and stroller 11 can be stopped by the parent stepping off the board or by dragging one of his/her feet on the ground. The board can also be stopped by the parent pressing a foot against one of the wheels while the parent is standing on the board. The board can also be stopped by activating the stroller brake, if one is provided. In addition, the new board can have its own brake that is integrated with the wheel, wheel mounting mechanism or the board.

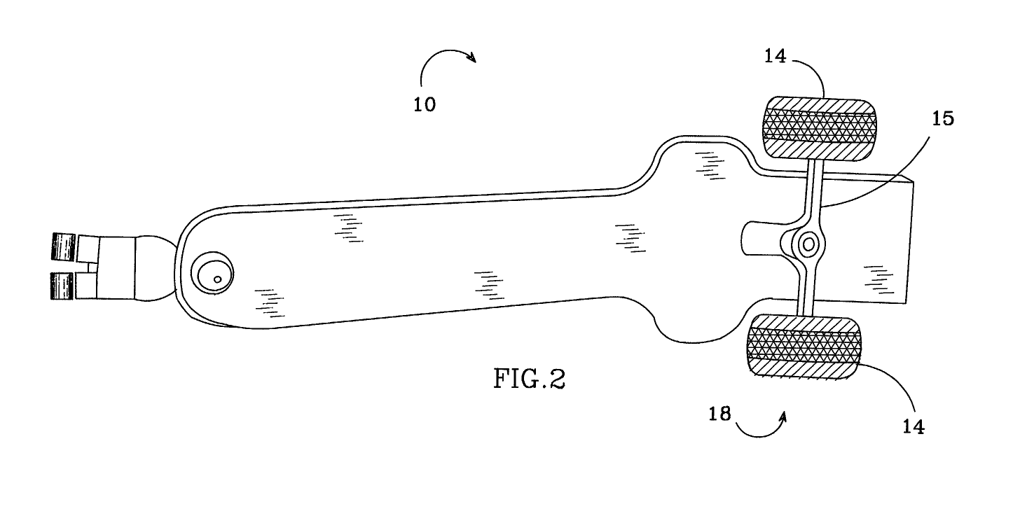

The board 10 can be many different shapes and sizes but as shown in FIGS. 2 and 3, it is preferably approximately 3 feet long, 4½ inches wide at its narrow section, 8¾ inches wide at its widest section around the wheels, and ¾ of an inch thick. The section of the board 10 in the area over the wheels 14 is wider to allow both feet to be comfortably placed at the rear of the board. The board has a narrow back section 18 directly over the wheels. This allows the board 10 to be lower to the ground while at the same time avoiding contact between the wheels 14 and the under surface of the board 10 when it is pivoted over the wheel mechanism. The board 10 can use many different commercially available wheel mechanisms 15, with the preferred mechanism being Invader™ S/C skateboard truck with a 10 inch skateboard axle. The wheels 14 can have many different shapes and sizes but are preferably commercially available rugged all terrain skateboard wheels such as XT Wheelz™A/T, that allow the new board to be used on many different surfaces.

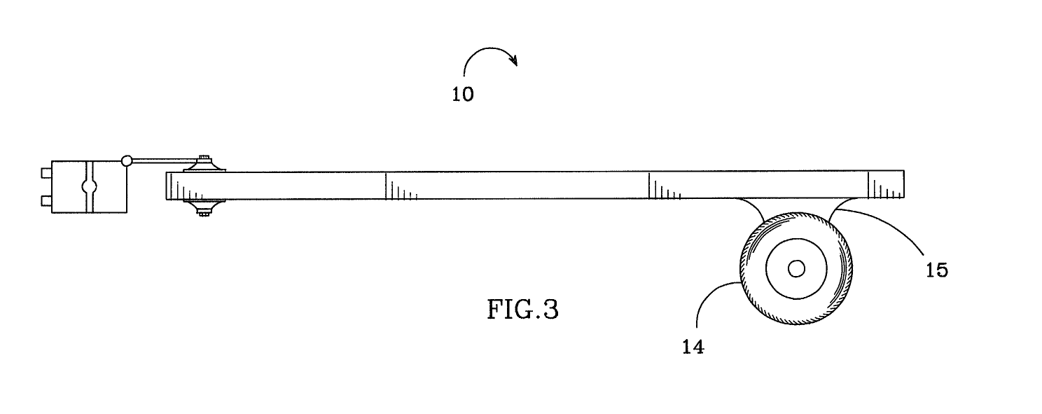

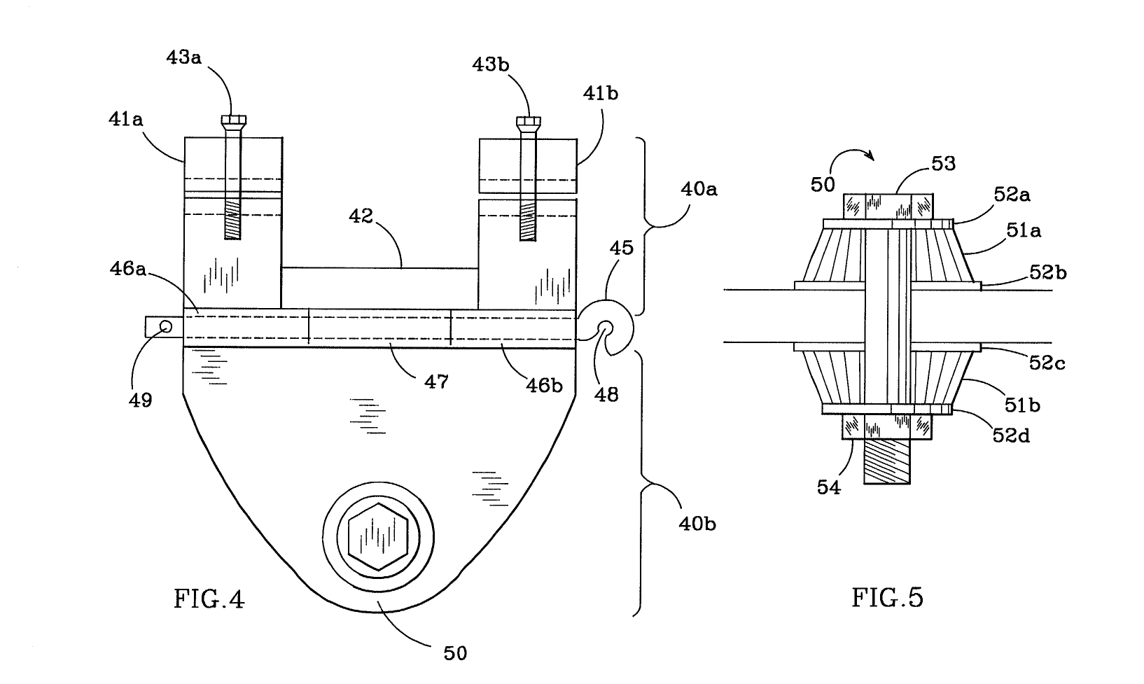

FIG. 4 shows the bracket 12 which is attached to the new board 10 on its end opposite the wheels 14. It provides attachment to the rear wheel axle on the stroller. The bracket attaches to the center front of the board 10 by a attachment assembly 50 shown in FIG. 5. It comprises two rubber spacers 51a and 51b, four metal washers 52a-d, a bolt pin 53 , and a nut 54. The spacers 51a and 51b are wider at the bottom. The spacer 51a has washers 52a and 52b on its top and bottom surfaces respectively, and spacer 51b has washers 52c and 52d on its top and bottom surfaces respectively. Spacer 51b is on the bottom of the board 10 with washer 52c against the board's surface, and spacer 51a is on the top the board with washer 52b against the board. The washers and spacers have a hole in the middle, all of which are aligned with a hole in the board 10. The bolt pin 53 is passed the aligned holes and the nut 54 is threaded onto the threaded end of the bolt. As the nut 54 is tightened, the washers and spacers are compressed between the nut and the head of the bolt 53.

The spacers 51a and 51b can be compressed which allows the board to pivot in relation to the stroller, about its longitudinal axis. This also allows the board 10 to move in relation to the stroller such that the vertical angle between the two can vary. The board 10 can also rotate around the pin such that the horizontal angle between the stroller and board can vary. As the pin is tightened on the nut, the rubber spacers are compressed, which stiffens the pivot point. The more the rubber spacer is compressed, the more force will be required to pivot the board 10 or the change the angles between the board and stroller. This provides an adjustment point for customizing the amount of force needed to pivot and turn the board.

Referring again to FIG. 4, the bracket 12 also has axle clamps 41a and 41b that attach the bracket to the stroller axle. Each clamp is held to the bracket body 42 by two threaded screws 43a and 43b that pass through their respective clamp and turn into a mating hole in the bracket body 42. Each clamp 41a and 41b has a half cylinder cavity that matches with a opposing half cylinder cavity on the bracket body to form a full cylinder cavity. To attach the bracket 12 to an axle, the threaded screws are turned out of the bracket body 42 and the clamps 41a and 41b are removed from the bracket body. The axle is then positioned within the bracket body's 42 half cylindrical cavity. The clamps 41a and 41b are then placed against the axle such that the axle is within the half cylinder clamp cavity. The threaded screws 43a and 43b are passed through the clamp and turned into the respective threaded hole in the bracket body. As the threaded screws 43a and 43b are turned, the clamp and bracket body serve as a vice to hold the axle firmly between the two.

The bracket 40 also has quick release pin 45 that holds part of the axle section of the bracket body 40a to the board section of the bracket body 40b. The axle section 40a has two axially aligned sleeves 46a and 46b on its edge opposite the bracket clamps with an open section between the two sleeves. The board section 40b has a sleeve on the center of its edge opposite the nut and bolt assembly 50, that axially fits in the opening between the axle section sleeves 46a and 46b to form one continuous sleeve. The pin 45 has a head 48 at one end and a hole 49 for a pin at the other end, is inserted into the sleeve. A cotter pin, or other pin, is inserted into the cotter pin hole 48 to hold the pin in the sleeve.

When the pin is inserted, it holds the axle section 40a to the board section 40b. The pin 47 can be quickly removed from the sleeve by removing the cotter pin and sliding the pin out of the sleeve. This provides a means to quickly and easily separate the board from the stroller without removing the clamps 41a and 41b. This is particularly useful when collapsing the stroller for storage. Removal of the pin is a much easier way to separate the two compared to removing the clamps.

The pin and sleeve also serve as a hinge that is perpendicular to the longitudinal axis of the board 10. The wheeled end of the board 10 can be lifted and the board will rotate up about the hinge with the front of it staying attached to the stroller. The board can be fixed and stored against the back of the stroller without separating the bracket 40 from the stroller. This is particularly useful if the parent wants the stroller for jogging or walking, but does not want to separate the board from the stroller.

The bracket body can be made of many different rigid materials and is preferably made from a light weight metal such as aluminum. The screws and pins are also made of a metal.

Although the present invention has been described in considerable detail with reference to certain preferred configurations thereof, other versions are possible. Therefore, the spirit and scope of the appended claims should not be limited to their preferred versions contained therein.

I claim:

1. A wheeled board for propelling a stroller, comprising:
an elongated rigid platform having a top and bottom surface;
a bracket mounted on said platform, said bracket attaching said platform to said stroller; and
at least one wheel mounted on said platform such that said at least one wheel contacts the ground when said platform is attached to said stroller, said wheels turning on the ground when said stroller is propelled, said stroller and board moving in unison.

2. The wheeled board of claim 1, wherein said bracket is mounted to one end of said platform and said at least one wheel is mounted at the other end of said platform.

3. The wheeled board of claim 2, wherein said wheels are mounted on the bottom surface of said platform.

4. The wheeled board of claim 1, wherein said at least one wheel comprises two wheels mounted to said platform's bottom surface.

5. The wheeled board of claim 1, wherein said stroller includes a rear axle, said bracket attaching said platform to said rear axle.

6. The wheeled board of claim 5, wherein said bracket includes at least one axle clamp to attach said platform to said rear axle.

7. The wheeled board of claim 1, wherein said bracket provides a pivot point between said platform and said stroller.

8. The wheeled board of claim 7, further comprising a bolt pin having a bolt head, a nut and two compressable spacers, said bracket attached to said board by said bolt pin passing through said board, said nut mating with said bolt to hold said bolt on said platform, said two spacers held on said bolt pin and nut, one said spacer between said bolt head and platform, the other said spacer between said nut and platform.

9. The wheeled board of claim 1, wherein said stroller includes a rear axle and said bracket includes at least on axle clamp to attach said platform to said rear axle, said bracket further comprising a hinge between said board and said at least one clamp, said hinge allowing said platform to be rotated about said at least one clamp.

10. The wheeled board of claim 1, wherein said bracket provides a pivot point between said stroller and said platform allowing said platform to pivot about its longitudinal axis.

11. The wheeled board of claim 1, wherein said bracket provides a pivot point between said stroller and said platform allowing the horizontal angle between said stroller and said platform to be varied.

12. A stroller, comprising:
a stroller frame;
a front wheel mounted on said frame;
a pair of rear wheels mounted on a rear axle, said rear wheels and axle mounted on said frame;
a child seat mounted on said frame;
a wheeled board attached to said rear axle, said board comprising;
an elongated rigid platform having a top and bottom surface;
a bracket mounted on said platform, said bracket attaching said platform to said stroller; and
at least one wheel mounted on said platform such that said at least on wheel contacts the ground when said platform is attached to said stroller, said wheels turning on the ground when said stroller is propelled, said stroller and board moving in unison.

13. The stroller of claim 12, wherein said bracket is mounted to one end of said platform and said at least one wheel is mounted at the other end of said platform.

14. The stroller of claim 12, wherein said wheels are mounted on the bottom surface of said platform.

15. The stroller of claim 12, wherein said at least one wheel comprises two wheels mounted to said platform's bottom surface.

16. The stroller claim 12, wherein said bracket includes at least one axle clamp to attach said platform to said rear axle.

17. The stroller of claim 12, wherein said bracket provides a pivot point between said platform and said stroller.

18. The stroller of claim 12, further comprising a bolt pin having a bolt head, a nut and two compressable spacers, said bracket attached to said board by said bolt pin passing through said board, said nut mating with said bolt to hold said bolt on said platform, said two spacers held on said bolt pin and nut, one said spacer between said bolt head and platform, the other said spacer between said nut and platform.

19. The stroller of claim 12, said bracket includes at least on axle clamp to attach said platform to said rear axle, said bracket further comprising a hinge between said board and said at least one clamp, said hinge allowing said platform to be rotated about said at least one clamp.

20. The stroller of claim 12, wherein said bracket provides a pivot point between said stroller and said platform allowing said platform to be pivoted about its longitudinal axis.

21. The stroller of claim 12, wherein said bracket provides a pivot point between said stroller and said platform allowing the horizontal angle between said stroller and said platform to be varied.
